(19) United States
(12) Patent Application Publication
(10) Pub. No.: US 2021/0148209 A1
(43) Pub. Date: May 20, 2021

(54) DISSOLVABLE EXPLOSIVE PROPPANT STRUCTURES

(71) Applicant: Halliburton Energy Services, Inc., Houston, TX (US)

(72) Inventors: Daniel Joshua Stark, Houston, TX (US); Lee J. Hall, The Woodlands, TX (US); Robert Ross Nellums, Littleton, CO (US)

(21) Appl. No.: 16/624,528

(22) PCT Filed: Jul. 31, 2017
(86) PCT No.: PCT/US2017/044746

§ 371 Date: Dec. 19, 2019

(51) Int. Cl. E21B 43/263; C09K 8/80; E21B 43/267

(52) U.S. Cl. CPC E21B 43/263; E21B 43/267; C09K 8/805

(57) ABSTRACT

The present disclosure provides composite structures and methods of use for delivering explosive proppant particles to a subterranean formation. The composite structure may comprise one or more packagings disposed about a plurality of explosive proppant particles. The explosive proppant may be become exposed and triggered to create micro-seismic events, which may be used to determine the subterranean formation geometry or other properties in the formation.

### BACKGROUND

The present disclosure relates to methods and systems for measuring and monitoring subterranean formations.

Hydraulic fracturing is used to improve well productivity by injecting fluid under pressure into a selected zone of a reservoir. The pressure causes the formation and/or enlargement of fractures in this zone. Proppant may be positioned in the fractures with the injected fluids before fluid pumping is halted to prevent total closure of the fractures. The proppant thus holds the fractures open, creating a permeable and porous path, open to fluid flow from the reservoir formation to the wellbore. Recoverable fluids, such as oil and gas, or water are then pumped or flowed to the surface.

The information on the geometry of the generated hydraulic fracture networks in a given reservoir formation is often helpful in determining the design parameters of future fracture treatments (such as types and amounts of proppant or fluids to use), establishing the further well treatments to be employed, designing future wells to be drilled, managing production, etc. Certain methods for obtaining this information have used pressure and temperature analysis, seismic sensor (e.g., tilt-meter) observational analysis, and micro-seismic monitoring of fracture formation during fracturing processes. Each of these methods have their drawbacks, including but not limited to complicated de-convolution of acquired data, reliance on assumed parameters, educated “guesswork” as to the connectivity of various mapped seismic events, and problems associated with reliance on mapping-while-fracturing methods, namely, measuring the shape of the fractures during formation (rather than after closure or during production), measuring fractures which may not be conductive to the wellbore, acoustic “noise” from the fracturing procedures, or an inability to distinguish between seismic events that are caused by fracture formation or other processes.

### BRIEF DESCRIPTION OF THE DRAWINGS

These drawings illustrate certain aspects of some of the embodiments of the present disclosure, and should not be used to limit or define the claims.

FIG. 1 is a diagram illustrating treatment and monitoring wells with arrayed sensors for detection and recording micro-seismic events caused during hydraulic fracturing.

FIG. 2 is a diagram illustrating a simple fracture model.

FIG. 3 is a diagram illustrating a composite structure containing a plurality of explosive proppant in accordance with certain embodiments of the present disclosure.

FIG. 4 is a diagram illustrating a composite structure containing a plurality of explosive proppant in accordance with certain embodiments of the present disclosure.

FIG. 5 is a diagram illustrating a composite structure containing a plurality of explosive proppant in accordance with certain embodiments of the present disclosure.

FIG. 6 is a diagram illustrating a composite structure delivery system in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

The present disclosure relates to methods, systems, and materials for measuring and monitoring subterranean formations. More particularly, the present disclosure relates to methods, systems, and materials for delivering explosive proppant to a wellbore to use micro-seismic events to measure subterranean formation geometry.

The present disclosure provides methods comprising at least injecting a composite structure into a portion of a wellbore, wherein the composite structure comprises at least one explosive proppant particle; a carrier fluid; and one or more dissolvable packaging components. The dissolvable packaging components of the composite structure may surround or contain the explosive proppant particles and may be configured to dissolve, break down, erode, disintegrate, or otherwise open to at least partially expose the explosive proppant particles within packaging to the wellbore. Thereafter, the explosive proppant particles may be at least partially crushed, thereby detonating and generating a micro-seismic event.

Previously suggested practices using explosive particles may have significant drawbacks, including the transport and handling of explosive particles at the surface and during pumping, exposure of explosive particles to very high pressures during operations, chemical compatibility with treatment and wellbore fluids, difficulty in timing the explosions given the particles' lengthy exposure to wellbore fluids, the risk of explosive particles becoming stuck in the well completion string, pumping and mixing equipment, etc. Further, some of the proposals require the inclusion of power sources, electronics, etc., in the injected particles that may be both impractical and prohibitively expensive at the sizes required to infiltrate a fracture and proppant.

Among the many potential advantages to the methods, compositions, and systems of the present disclosure, only some of which are alluded to herein, the methods, compositions, and systems of the present disclosure may, among other benefits, provide for safer, more efficient, and more effective transport and handling of explosive proppant at the surface and during pumping into the wellbore. The methods, compositions, and systems of the present disclosure may also protect the explosive proppant during exposure to very high pressures, temperatures, or other stresses within the wellbore. The methods, compositions, and systems of the present disclosure allow for increased control of the location and the timing of explosive proppant detonation and the generation of the subsequent micro-seismic event by preventing the explosive proppant from becoming stuck, and subsequently detonating, in the well completion string, unintended portions of the subterranean formation, or pumping and mixing equipment. The methods, compositions, and systems of the present disclosure also allow for more accurate delivery of specific, known concentrations of the explosive proppants to the location of interest within the well. Finally, the methods, compositions, and systems of the present disclosure allow for delivery of higher concentrations of explosive proppant to the location of interest within the well. As the explosive content itself can be small, delivering multiple explosive proppant particles to the right location may be needed in order for the treatment to be effective. Moreover, if the explosive proppant particles are released too soon or without packaging, they could be delivered to other locations in the wellbore. Furthermore, if the explosive proppant particles have a density significantly different than other conventional proppant particles that are simultaneously introduced into the well, the explosive proppant particles will not flow to the same locations as the conventional proppant particles. The packaging components according to the methods and compositions of the present disclosure can help counter any such density difference, allowing the explosive proppant particles to travel to the desired location within the well along with the conventional proppant particles. Once there, the packaging component may degrade or dissolve, depositing the explosive proppant particles at the desired site, much closer than would otherwise be the case.

While the making and using of various embodiments of the present disclosure are discussed in detail below, a practitioner of the art will appreciate that the present disclosure provides applicable inventive concepts that can be embodied in a variety of specific contexts. The specific embodiments discussed herein are illustrative of specific ways to make and use the disclosure and do not limit the scope of the present disclosure.

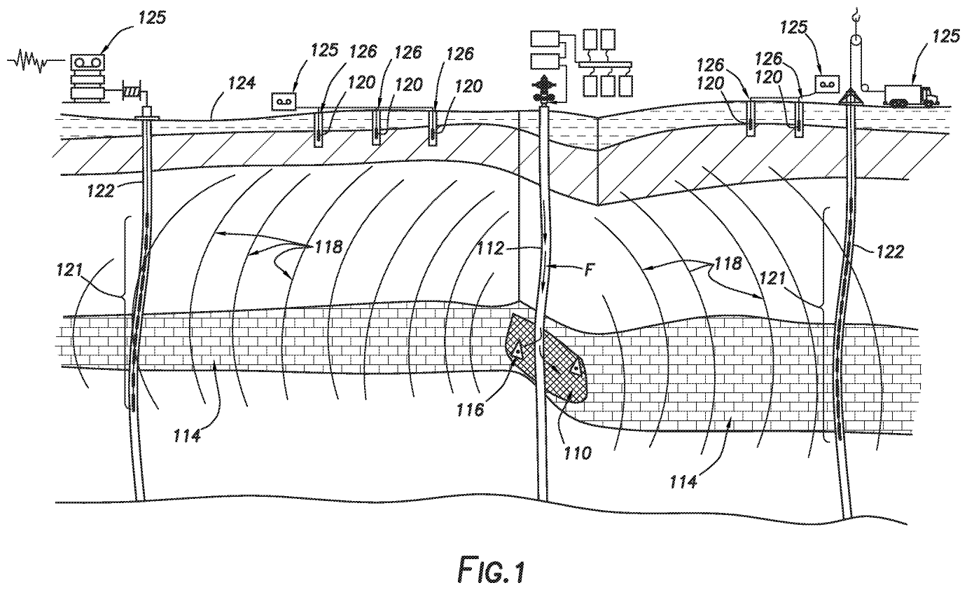

FIG. 1 is a schematic illustration of treatment wells 112 and monitoring wells 122 with sensors arrays for acquisition and recording of waves originating from the fracture space and traveling through the reservoir formations 114. In a typical drilling operation, several wellbores are used in a field to maximize production of hydrocarbons. Improving flow of fluids to the producing well using hydraulic fracturing techniques can enhance production of hydrocarbons. The induced and pre-existing fractures create conductive pathways into the producing wells for fluids to flow to the well bore. Fractures formed by hydraulic fracturing methods may extend from the wellbore into the reservoir rock for as much as several hundred feet. As explained above, proppant materials may be pumped into the fractures during formation to “prop” or maintain the fractures in an open, conductive state. Upon cessation of pumping, the opened or hydraulic fractures collapse or close for all practical purposes, leaving “propped fractures” open which are of smaller dimension. “Effective fractures,” meaning the fractures providing production fluid conductivity to the wellbore, may be of even smaller dimension.

An exemplary hydraulic fracture 110 is formed by pumping a fracturing fluid into the treatment well 112 at a rate sufficient to increase downhole pressure to exceed the fracture gradient of the reservoir formation 114. The increased pressure causes the formation 114 to fracture, which allows the fracturing fluid to enter and extend the fracture further into the formation 114. The fracturing of formation 114 and other events often related to expansion or relaxation of formation rock that change the in-situ stress profile and pore pressure distribution create a plurality of micro-seismic events at one or more locations 116 within the fracture 110.

As used herein, the term “micro-seismic event” (and similar) refers to any event that causes a small but detectable change in stress and pressure distributions in a reservoir formation, including those caused by slippages, deformation, and breaking of rock along natural fractures, bedding or faults, creation of fractures or re-opening of fractures, and events artificially created by fracturing operations or caused by an explosion, implosion, exothermic reaction, etc.

Each micro-seismic event at locations 116 generates waves 118, which may be seismic waves or acoustic waves. The waves generated may be of various types such as body waves, surface waves and others. For the purposes of this disclosure, the body waves are the main point of interest. There are two types of body waves: compression, pressure or primary waves (called P-waves), and shear or secondary waves (called S-waves). The P-waves and S-waves travel through the earth formations at speeds governed by the bulk density and bulk modulus (rock mechanical properties) of the formation. The rock mechanical properties of the formation may vary according to mineralogy, porosity, fluid content, in-situ stress profile, temperature, and other factors.

The terms “seismic wave,” “seismic pulse,” “acoustic wave,” “acoustic pulse” and similar, as used herein, refer to detectable and measurable P- and S-waves caused by the micro-seismic event. Each type of wave may be detected and measured by corresponding sensor equipment, generally referred to herein as “seismic sensors” or “acoustic sensors” or similar.

The waves 118 propagate away from each micro-seismic event at locations 116 in all directions and travel through the reservoir formations 114. These waves are detected by a plurality of seismic sensors, such as seen at 120 and 121. These sensors (or receivers), which are capable of detecting and measuring micro-seismic events, can be of any type, such as seismographs, tilt meters, piezoelectric sensors, accelerometers, distributed optical sensors (such as distributed acoustic sensing), quasi-distributed optical sensors (such as strings of fiber Bragg gratings), transducers, ground motion sensors, multi-axis sensors, geophones and/or hydrophones, or any combination of these. Seismic sensors and sensor arrays may comprise commercially available sensor/array products or other sensors/arrays that are known in the industry. The seismic sensors are sensitive instruments capable of detecting micro-seismic events. The seismic sensors can be placed in a wellbore of one or more observation or monitoring wells 122. Sensors can also be placed at or near the surface 124, preferably in shallow boreholes 126 drilled for that purpose. A typical shallow borehole 126 for such a purpose may be about ten feet to about three hundred feet deep. In addition to or instead of these other locations, the seismic sensors also can be placed within treatment well 112.

In certain embodiments of the present disclosure, certain borehole sensor array systems and surface monitoring equipment may be capable of detecting even very small amplitude events (micro-seismic events) that cause relatively small changes in stress and pressure distributions from considerable distances. For example, some such systems and equipment may be capable of detecting micro-seismic events that cause pressure changes of as little as tens of pounds per square inch (psi), although detection of even smaller changes in stress and pressure may be possible. Commercially available equipment that may be suitable for detecting these micro-seismic events includes hydrophones, integrated electronic piezoelectric (IEPE) class of accelerometers, and pressure transducers. Commercially available hydrophones suitable hydrophones suitable for use in certain embodiments of the present disclosure may be adapted from the Acoustic Conformance Xaminer® Service, available from Halliburton Energy Services, Inc., Houston, Tex. For reference, a measurable micro-seismic event may be equivalent to an event caused by detonation of approximately 1 milligram of common explosive material, such as TNT. Additionally, data acquisition, telemetry and processing systems may be used to receive and process data related to these small amplitude events. Consequently, micro-seismic events, which occur at much higher frequencies than surface seismic surveys, can be measured, even in the presence of “noise” caused by other surface and downhole activities.

In some embodiments, the recorded wave data (e.g., from P- and S-waves) is analyzed in a process referred to as “mapping” or “imaging,” which calculates locations of the events in 3-dimensional reservoir space. In some embodiments, a statistical best-fit method may be used to map events in terms of distance, elevation, and azimuth. Analysis of the recorded and measured seismic events may proceed using any suitable methods and systems, including those known in the art. Certain computer software for analyzing and displaying the measurements and results is commercially available. For example, such products and services are available from Halliburton Energy Services, Inc., under trade names such as FracTrac® and TerraVista® visualization and interpretation.

The accuracy of mapping recorded events may be dependent on the number of sensors spaced across the reservoir and by the distance of the sensors from the measured events. It may be beneficial, therefore, to place sensors in the treatment well, either instead of or in addition to sensors placed elsewhere. Certain micro-seismic monitoring methods may be less effective since the monitoring process usually takes place during hydraulic fracturing, which may involve stresses and/or other events that may produce “noise” in the form of interfering signals or waves. In these situations, the recorded data may include the “noise” of the fracturing process and the results (mapped event locations) may represent opened fractures rather than propped or effective fractures.

Sensors 120 and 121 detect and acquire data regarding waves that are generated by micro-seismic events 116 and traveled through the formations. The data may be transferred to data processing systems 125 for a preliminary analysis at the well site either in real-time or shortly after the data has been acquired, and/or a more in-depth analysis may be performed offsite and/or at a later time, for example, after the raw data is collected and quality-checked. After analysis, the results (maps of the fracture networks) may be used in development planning for the reservoir and field, and in designing future hydraulic fracturing jobs.

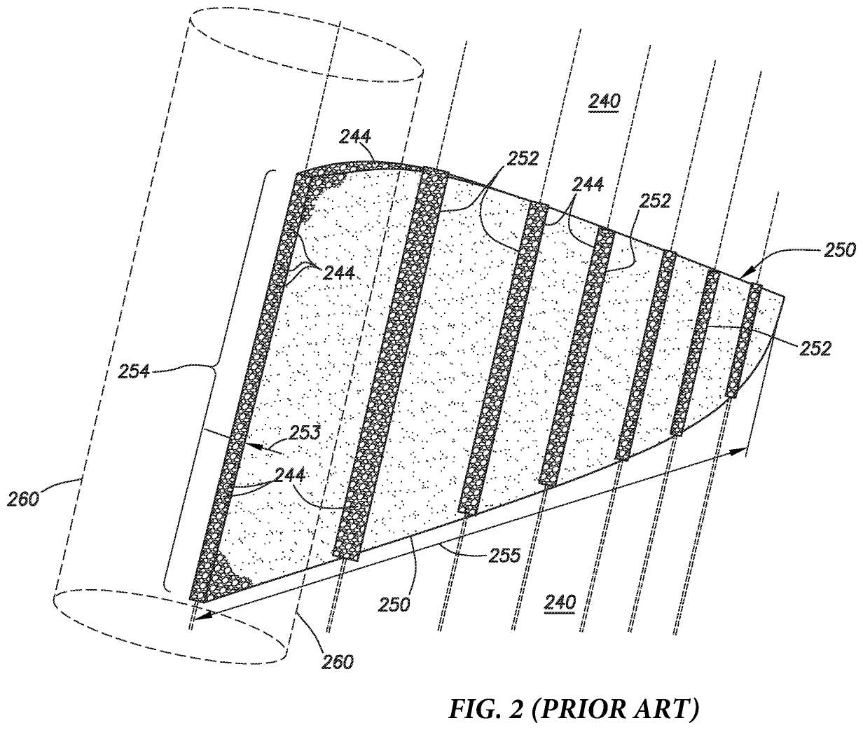

FIG. 2 is a graphical representation of a simple fracture model. A simple bi-wing fracture plane 240 (only one wing shown) extends into a reservoir formation. A wellbore 260 (cased or uncased) is representative of the wellbore through which the fracturing fluid is introduced into the zone, i.e. the “treatment well.” The fracturing process results in formation of fractures that are initially propagated along planes, the orientation of which are dictated by the in-situ stress profile of the formation. The planes may radiate from the wellbore 260. Proppant particles 244 are pumped into the fractures along with the fracturing fluid. After pumping of the fluid ceases, the fracture closes or seals to an effective fracture 250, indicated graphically in cross-sections 252. Of course, fractures involved in the methods of the present disclosure may have a much greater length 255 than width 253 and can vary in height 254. These dimensions may be used, among other ways, for selecting size and amounts of proppant, particles and fluid injected into the formation, design of a fracturing plan, etc. In particular, fracture height 254 may be used to form the basis for accurate volume estimates in various fracture models. Further, measurements obtained in the near-wellbore portion of a fracture may be used to determine the location of the explosive proppant in the fracture as will be described in further detail below. In turn, this allows for accurate determination of other materials having similar density values. When introducing explosive materials and other materials having slightly different densities, a density gradient may be calculated, allowing for better estimation of proppant placement within the fracture.

As discussed above, micro-seismic events may be generated using a plurality of explosive proppant particles. These explosive proppant particles comprise a reactive core. The reactive core may comprise one or more chemicals that can be ignited or detonated, which may be combined at any percentage by any number of means known in the art, in any total weight to achieve a sufficient specific energy to generate the required micro-seismic event strength. Exemplary core materials include: high-order explosives such as pentaerythritoltetranitrate (PETN), hexamethylenetetraminemononitrate, cyclotrimethylenetrinitramine (RDX), cyclotetramethylenetrinitramine (HMX), hexanitrohexaazaisowurtzitane (HNIW), hexanitrosilbene (HNS), picryl amino-3,5-dinitropyridine (PYX), diazodinitrophenol (DDNP), copper(I) 5-nitrotetrazolate (DBX-1), lead azide, silver azide, hydrazine azide, trinitrotoluoene (TNT), polyazapolycyclic caged polynitramines (CL-20), 2,4,6-trinitrophenylmethylnitramine (tetryl); energetic plasticizers such as nitroglycerine (NG), ethyleneglycoldinitrate (EGDN), acetone peroxide, bis(2,2 di-nitropropyl) acetal/formal (BDNPA/BDNPF), triethylene glycol-dinitrate (TEGDN), diethylene glycol-dinitrate (DEGDN), trimethylolethane trinitrate (TMETN), 1,2,4-Butanetrioltrinitrate (BTTN), nitratoethyl nitramine (NENA), Potassium-Graphite, mixtures of Magnesium and Iodine, mixtures of Magnesium and Barium Peroxide, mixtures of Aluminum and Iodine, Sodium Aluminum Hydride; plasticizers such as dioctyladipate (DOA), isodecyl perlargonate (IDP) bis(2-ethylhexyl) sebacate, dioctyl maleate (DOM), dioctyl phthalate (DOP), polyisobutylene, plasticizing oil; oxidizers such as silver nitrate, ammonium nitrate (AN), hydroxylammonium nitrate (HAN), ammonium dinitramide (AND), potassium nitrate, barium nitrate, sodium nitrate, ammonium perchlorate, potassium perchlorate, sodium perchlorate, lead nitrate, anhydrous hydrazine, hydrazinium nitrate, nitromethane, nitro-ethane, nitro-propane; sensitizers such as diethylamine, triethylamine, ethanolamine, ethylendiamine, morpholine, nitromethane; reactive metal powders such as aluminum, magnesium, boron, titanium, zirconium Potassium Azidodisulfate (KN₃O₆S₂), Bismuth Nitride (BiN), mixtures of Magnesium and Iodopentoxide (Mg+I₂O₅), mixtures of Magnesium and Silver Nitrate (Mg+AgNO₃), mixtures of Magnesium and Ceric Ammonium Nitrate (Mg+(NH₄)₂Ce(NO₃)₆), mixtures of Magnesium and Barium Peroxide (Mg+BaO₂), mixtures of metals and Iodine (Mg+I₂, Al+I₂, Zn+I₂), mixtures of Boron and Silver Difluoride (B+AgF₂); hydrocarbon fuels such as diesel, kerosene, gasoline, fuel-oil, motor-oil; energetic binders such as polyglycidyl-nitrate (PGN), polyglycidyl-azide (GAP), polynitratomethyl methyloxetane (NMMO), poly(3,3 bis(azidomethyl)oxetane (BAMO), poly (nitramino-methyl-methyl-oxetane (NAMMO), 1,3,3-trinitroazetidine (TNAZ); binders such as polybutadiene prepolymers, polypropylene glycol (PPG), polyethylene glycol (PEG), polyesters, polyacrylates, polymethacrylates, ethylenevynil acetate; other materials such as micro particles of resins, polymeric foam, polyurethane rubber, stearic acid, carbon powder, silica; and tagging agents, such as, 2,3-dimethyl-2,3-dinitrobutane (DMDNB, DMNB).

In certain embodiments, the reactive core may comprise a primary explosive material and a secondary explosive material. The reactive core may comprise one or more materials in any amount sufficient to generate the desired micro-seismic event without disrupting the surrounding features of the subterranean formation or the proppant pack. In certain embodiments, the reactive core may comprise a total amount of explosive materials in a total amount less than or equal to about 50 mg. The primary explosive material and the secondary explosive material may be present in a ratio sufficient to generate the desired micro-seismic event. In certain embodiments, the ratio of primary explosive material to secondary explosive material is in the range of from about 1:12 to about 1:1. The primary explosive material may comprise a chemical or mixture capable of generating heat in an amount sufficient to ignite the secondary explosive material. In these instances, because the primary explosive material must ignite the secondary explosive material to cause the micro-seismic event, a certain critical mass of the primary explosive material may be required to ignite the secondary explosive material. In certain embodiments, the primary explosive material is present in an amount of greater than or equal to about 4 mg. In certain embodiments, the primary explosive material is selected to be a water sensitive material that may generate an explosive charge when exposed to water. In certain embodiments, the primary explosive material is selected from the group consisting of potassium azidodisulfate, bismuth nitride, magnesium and iodopentoxide, magnesium and silver nitrate, magnesium and ceric ammonium nitrate, magnesium and barium peroxide, metal and iodine, and boron and silver difluoride. The secondary explosive material may comprise a chemical or mixture capable of generating an explosion sufficient to create a micro-seismic event. At the desired time, the primary explosive material is triggered to generate sufficient head to cause the secondary explosive material to explode and create the desired micro-seismic event. In certain embodiments, the secondary explosive material is selected from the group consisting of copper(I) 5-nitrotetrazolate (DBX-1), lead azide, potassium-graphite, magnesium-iodine, a magnesium-barium peroxide mixture, an aluminum-iodine mixture, sodium aluminum hydride, magnesium and silver nitrate, and magnesium and ceric ammonium nitrate.

A person of ordinary skill in the art would understand that the material for the reactive core may be chosen to generate the desired micro-seismic events. These micro-seismic events are generated by an explosive reaction involving the materials of the reactive core. Accordingly, the materials may be selected based on the desired intensity or timing of the micro-seismic events. The reactive materials may be chosen to generate stronger or weaker micro-seismic events. Alternatively, the reactive materials may be chosen to generate the micro-seismic events at a desired time or in response to a desired event. Furthermore, certain reactive materials may react slower or faster than others. Different reactive materials also may react based on exposure to particular triggers. These triggers may include pH, temperature, salinity, chemical potential, reduction potential, and mechanical forces such as impact, shear, or compression. For example, certain reactive materials may react at a pH at or below 1. Other reactive materials may react only at temperatures above 100° C. Still other reactive materials may react only in the presence of water.

The explosive proppant particles may further comprise a shell. The shell may generally surround the reactive core to isolate it from its surroundings. The shell may be used to isolate the reactive materials from one or more triggers that would cause the reactive core to react. In certain embodiments, the shell may comprise a layer of inert material, such as a thin polymer layer. The polymer layer may comprise poly(vinyl chloride) (PVC), polyvinylidene chloride (PVDC), polyvinylidene fluoride (PVDF), poly(tetrafluoroethylene), cellulose acetate, cellulose acetate butyrate, or similar polymers or co-polymers. Such polymers also may incorporate a clay, graphite, graphene, hexagonal boronitride, or similar plate-like phase as a reinforcing barrier in a composite coating. In certain embodiments, the shell may isolate the reactive core from water. Once the explosive proppant particle is placed at its desired location within a fracture, the shell may be crushed as the fracture begins to close. The crushed shell may then allow water from the surroundings to interact with the reactive core, generating a reaction and subsequent micro-seismic event.

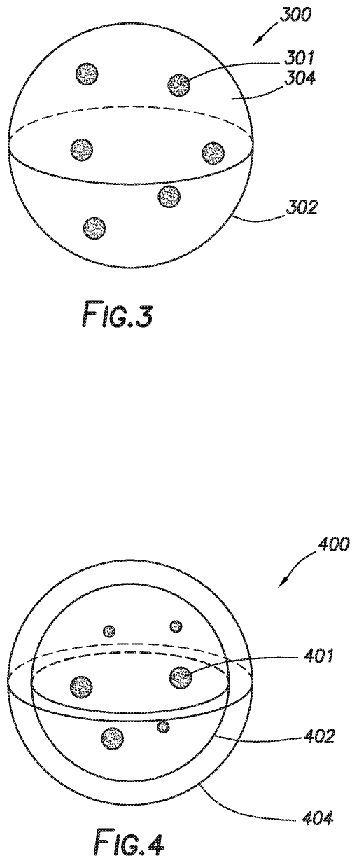

FIG. 3 is a graphical representation of a composite structure 300 according to certain embodiments of the present disclosure in the form of a generally spherical composite ball containing a plurality of explosive proppant particles 301 contained within packaging 302. While the embodiment of the composite structure 300 shown in FIG. 3 is spherical in shape, the composite structures of the present disclosure may be of other regular or irregular shapes. As shown in FIG. 3, explosive proppant particles 301 may be fully encapsulated by packaging 302. Within each packaging 302, there may be any number of explosive proppant particles 301. However, in other embodiments the packaging 302 may be at least partially disposed about the proppant particles 301. Packaging 302 may generally comprise any material that will degrade by means of melting, dissolution, stress-induced cracking or rupture, erosion, disintegration, or otherwise expose the explosive proppant 301 contained within packaging 302 to the wellbore. In certain embodiments, the packaging 302 may comprise one or more of the following materials: polyacrylamide (PA); polyacrylamide copolymers; polylactic acid (PLA); polyglycolic acid (PGA) polyvinyl alcohol (PVOH); a polyvinyl alcohol copolymer; a methyl methacrylate; an acrylic acid copolymer; or any combination of one or more of these materials.

In certain embodiments, packaging 302 may be a material that has a relatively low temperature melting point. For example, in accordance with some embodiments, packaging 302 may be formed from a polymer having a relatively low melting point, which may allow the release of the explosive proppant 301 as the composite structure 300 travels downhole in the wellbore where the temperature increases accordingly with depth. In further embodiments, packaging 302 may be formed from materials designed to disintegrate or break down at the pressures experienced downhole in the wellbore. For example, in accordance with some embodiments, packaging 302 may have a sufficient thickness to be stable for the pressure used at the surface, but may be disintegrate or break down at higher pressures, such as the hydrostatic pressures that are present downhole in the wellbore. In further embodiments, packaging 302 may be formed from materials that degrade when exposed to particular pH conditions. For example, in accordance with some embodiments, packaging 302 may be stable when used in an acidic fracturing fluid but dissolve as the surrounding pH drops due to exposure to carbonate formations.

In certain embodiments, packaging 302 may generally comprise any material that will degrade by means of melting, dissolution, stress-induced cracking or rupture, erosion, or disintegration when exposed to a chemical solution, a chemical reaction, an ultraviolet light, a nuclear source, mechanical impact or abrasion, or a combination thereof. These components may be formed of any degradable material that is suitable for service in a downhole environment and that provides adequate strength to encapsulate and protect explosive proppant particles 301. By way of example only, one such material is an epoxy resin that dissolves when exposed to a caustic fluid. Another such material is a fiberglass that dissolves when exposed to an oxidizing acidic or strong alkaline solution. Still another such material is a binding agent, such as an epoxy resin, for example, with glass reinforcement that dissolves when exposed to a chemical solution of caustic fluid or acidic fluid. Still another example is a composition comprising a mixture of sinter metals including an alkali metal or alkaline earth metal that may dissolve in response to temperature and salinity. Any of these exemplary materials could also degrade when exposed to an ultraviolet light or a nuclear source. Thus, the materials used to form packaging 302 may degrade by one or more of dissolving, breaking down, eroding, or disintegrating from exposure to certain wellbore conditions (e.g., pH, temperature, salinity, pressure gradient, and pressure), a chemical solution, a chemical reaction, or from exposure to an ultraviolet light or a nuclear source, or by a combination thereof. The particular material matrix used to form the dissolvable components of the packaging 302 may be customizable for operation within particular pH, pressure, pressure gradient, and temperature ranges, or to control the dissolution rate of dissolution of the packaging 302 when exposed to these conditions, a chemical solution, an ultraviolet light, a nuclear source, or a combination thereof.

In some embodiments, a carrier material 304 may be contained within degradable packaging 302. Carrier material 304 provides a buffer to protect explosive proppant particles 301 while the composite structure 300 being transported, handled, and delivered into a wellbore. For example, carrier material 304 may comprise a fluid. Fluids suitable for use as carrier material 304 include, but are not limited to, water, brine, emulsions, invert emulsions, muds, surfactants, aqueous or organic gels, and natural or synthetic oils. The fluid may have a viscosity that is sufficiently high so as to provide support for explosive proppant particles 301. Furthermore, carrier material 304 may comprise an inert solid. Inert solids suitable for use as carrier material 304 include, but are not limited to, ceramic particles, sand, resins, silica salt, rock salt, a polymeric material, wood pulp, and combinations of one or more of these materials. Carrier material 304 may isolate each individual explosive proppant particle 301 such that each explosive proppant particle 301 makes little or no contact with the other explosive proppant particles 301 or with the packaging 302. Carrier material 304 therefore protects explosive proppant particles 301 from external forces that might prematurely break the explosive proppant particles 301, thereby initiating the micro-seismic event described above. In this manner, the carrier material 304 mitigates, if not prevents, unintended stresses on the explosive proppant 301 during the handling, storage, transportation and conveyance into the well of the explosive proppant particles 301, which have the potential of causing unintended proppant detonation.

According to certain embodiments, the explosive proppant particles may be contained within more than one layer of packaging configured to degrade by one or more of dissolving, breaking down, eroding, disintegrating, or otherwise degrading and expose the explosive proppant according to different triggers or conditions. FIG. 4 is a graphical representation of a composite structure 400 containing a plurality of explosive proppant particles 401 contained within a first packaging 402 that is itself contained entirely within a second packaging 404. In certain embodiments, first packaging 402 may be formed from a material that may degrade by one or more of dissolving, breaking down, eroding, disintegrating, or otherwise degrading from exposure to a specific stimulus, such as certain wellbore conditions (e.g., pH, temperature, salinity, pressure gradient, and pressure), a chemical solution, a chemical reaction, or from exposure to an ultraviolet light or a nuclear source, or by a combination thereof. Likewise, second packaging 404 may be formed from a material that may degrade by one or more of dissolving, breaking down, eroding, disintegrating, or otherwise degrading from exposure to a specific stimulus, such as certain wellbore conditions (e.g., pH, temperature, salinity, pressure gradient and pressure), a chemical solution, a chemical reaction, or from exposure to an ultraviolet light, an electric or magnetic field, or a nuclear source, or by a combination thereof, wherein this stimulus may be different from the stimulus for first packaging 402. For example, the second packaging 404 may be configured to degrade by one or more of dissolving, breaking down, eroding, disintegrating, or otherwise degrading in response to a rise in temperature. Next, second packaging 402 may be configured to degrade by one or more of dissolving, breaking down, eroding, disintegrating, or otherwise degrading in response to exposure to high pH conditions. Accordingly, explosive proppant particles 401 may only be completely exposed to the wellbore once the composite structure 400 has been exposed to the requisite high temperature conditions followed by a subsequent high pH conditions inside the wellbore. As would be understood by a person of ordinary skill in the art having the benefit of the present disclosure, the composite structure 400 may further comprise any number of packaging layers to meet the goals of any particular project.

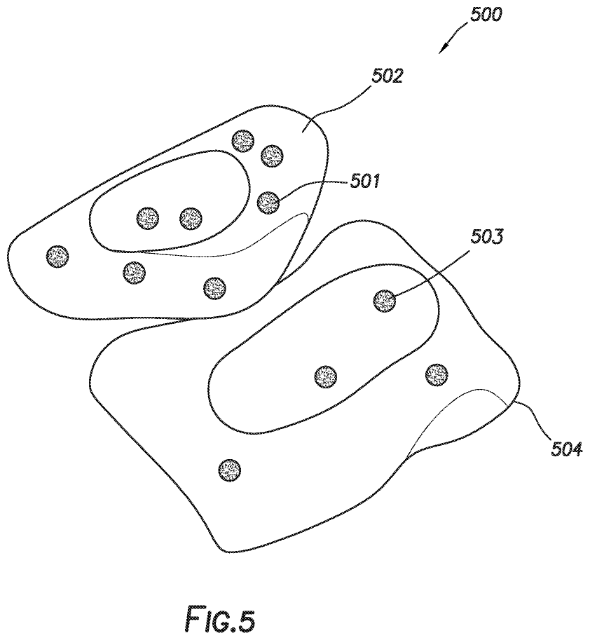

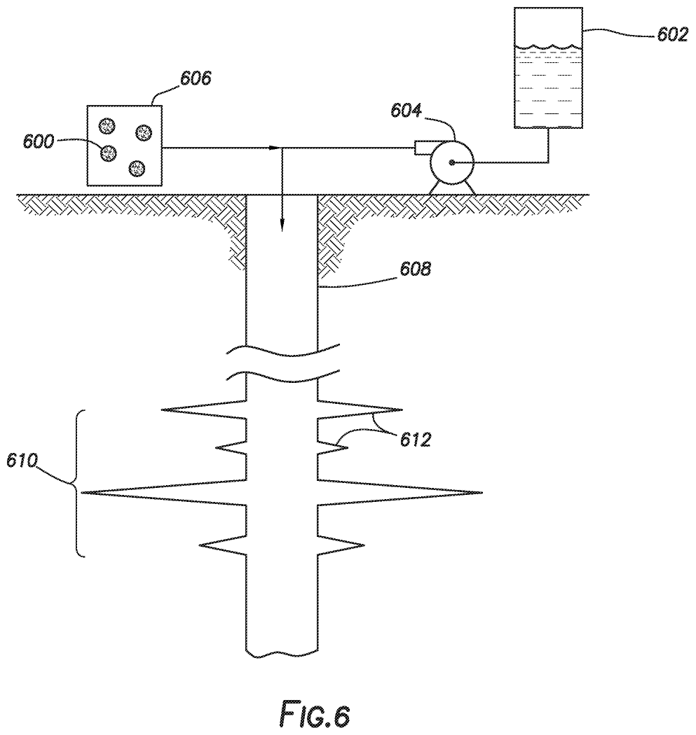

According to further embodiments, the explosive proppant particles may be contained within multiple packaging layers that are coupled to each other. FIG. 5 is a two-dimensional graphical representation of a composite structure 500 containing a first plurality of explosive proppant particles 501 fully contained or disposed within a first packaging 502 and a second plurality of explosive proppant particles 503 contained or disposed within a second packaging 504. In the embodiment shown, first packaging 502 is coupled to, and disposed adjacent to, second packaging 504. In certain embodiments, first packaging 502 may be adhered to second packaging 502 using any adhesive known in the art. In other embodiments, first packaging 502 may be integrally formed with second packaging 504. In certain embodiments, first packaging 502 may be formed from a material that may degrade by one or more of dissolving, breaking down, eroding, disintegrating, or otherwise degrading from exposure to a specific stimulus, such as certain wellbore conditions (e.g., pH, temperature, salinity, pressure gradient, and pressure), a chemical solution, a chemical reaction, or from exposure to an ultraviolet light, an electric or magnetic field, or a nuclear source, or by a combination thereof. Likewise, second packaging 504 may be formed from a material that may degrade by one or more of dissolving, breaking down, eroding, disintegrating, or otherwise degrading from exposure to a specific stimulus, such as certain wellbore conditions (e.g., pH, temperature, salinity, and pressure), a chemical solution, a chemical reaction, or from exposure to an ultraviolet light, an electric or magnetic field, or a nuclear source, or by a combination thereof, wherein this stimulus may be the same as or different from the stimulus for first packaging 502. A second plurality of explosive proppant particles 503 may be fully disposed within second packaging 504. Second packaging 504 may be configured to degrade by one or more of dissolving, breaking down, eroding, disintegrating, or otherwise degrading in response to a rise in temperature. Next, first packaging 502 may be configured to degrade by one or more of dissolving, breaking down, eroding, disintegrating, or otherwise degrading in response to exposure to high pH conditions. Accordingly, the first plurality of explosive proppant particles 501 may be released only in response to exposure to high temperature conditions and the second plurality of explosive proppant particles 503 may be released only in response to exposure to high pH conditions. As would be understood by a person of ordinary skill in the art having the benefit of the present disclosure, the composite structure 500 may further comprise any number of packaging layers to meet the goals of any particular project. Moreover, any combination of packaging coupled to other packaging or disposed within other packaging may be used to meet the goals of any particular project. For example, a first packaging may be disposed within a second packaging, and the second packaging may be coupled to, and disposed alongside, a third packaging.

As depicted in FIG. 6, the composite structures 600 containing explosive proppant particles may be communicated into the well by pumping a fracturing fluid supplied by a fluid source 602 via pump 604. For this example, in preparation to be delivered into the well, the composite structures 600 containing explosive proppant particles are stored inside a ball launcher 606, which is constructed to be operated to deliver the composite structures 600 into the well. In this manner, as further disclosed herein, in accordance with example implementations, the composite structures 600 have a form factor (i.e., dimensions, or geometry) that corresponds to the form factor of a frac ball (e.g., the composite structures 600 containing explosive proppant 601 has outer dimensions and geometry that are consistent with the outer dimensions of a frac ball), and as such, a conventional frac ball launcher may be used for purposes of deploying the composite structures 600 into the well.

As shown in FIG. 6, in accordance with certain embodiments, the ball launcher 606, or an equivalent device, is disposed downstream from the pump 604 so that the deployed composite structures 600 are not communicated through the flow path of the pump 604. When deployed into the well, the composite structures 600 travel downhole into the well through the casing 608 or through a central tubing string positioned from the surface to just above the perforated zone of the well 610. The composite structures 600 may degrade by one or more of dissolving, breaking down, eroding, disintegrating, or otherwise degrading at any point in the well. The composite structures 600 may also travel into the perforated zone of the well 610 to deploy the explosive proppant particles directly to the well perforations 612. Once in their proper location, the explosive proppant particles may generate a micro-seismic event as described above.

An embodiment of the present disclosure is a method that includes: introducing one or more composite structures into a portion of a wellbore, wherein the one or more composite structures each includes: a plurality of explosive proppant particles including a reactive core; a carrier material; a first packaging; and a second packaging; allowing one or more of the composite structures to reach a location within the portion of the wellbore; exposing the plurality of explosive proppant particles within the first packaging or the second packaging; and triggering the reactive core of the exposed explosive proppant particles to create a plurality of micro-seismic events.

In one or more embodiments described in the preceding paragraph, the reactive core includes a total amount of explosive materials that is less than or equal to about 50 mg. In one or more embodiments described above, the first packaging is fully disposed within the second packaging. In one or more embodiments described above, the first packaging is coupled to and disposed adjacent to the second packaging. In one or more embodiments described above, the step of exposing the plurality of explosive proppant further includes: allowing the first packaging to at least partially degrade in response to exposure to a first stimulus; and allowing the second packaging to at least partially degrade in response to exposure to a second stimulus. In one or more embodiments described above, the first stimulus is selected from the group consisting of erosion, impact, shear forces, a temperature change, a pH change, a pressure change, a pressure gradient change, a chemical solution, a chemical reaction, an ultraviolet source, and a nuclear source; and the second stimulus is selected from the group consisting of a temperature change, a pH change, a pressure change, a pressure gradient change, a chemical solution, a chemical reaction, an ultraviolet source, and a nuclear source. In one or more embodiments described above, the step of introducing the composite structure into a portion of a wellbore further includes: placing one or more composite structures into a ball launcher; inserting the composite structure into a wellbore treatment fluid; and injecting the wellbore treatment fluid into the portion of the wellbore. In one or more embodiments described above the reactive core includes a primary explosive material and a secondary explosive material. In one or more embodiments described above the primary explosive is selected from the group consisting of: potassium azidodisulfate, bismuth nitride, a mixture of magnesium and iodopentoxide, a mixture of magnesium and silver nitrate, a mixture of magnesium and ceric ammonium nitrate, a mixture of magnesium and barium peroxide, a mixture of metal and iodine, and a mixture of boron and silver difluoride. In one or more embodiments described above the secondary explosive is selected from the group consisting of copper(I) 5-nitrotetrazolate (DBX-1), lead azide, potassium-graphite, magnesium-iodine, a mixture of magnesium and barium peroxide, a mixture of aluminum and iodine, sodium aluminum hydride, a mixture of magnesium and silver nitrate, and a mixture of magnesium and ceric ammonium nitrate. In one or more embodiments described above the primary explosive material and the secondary explosive material are present in amounts having a ratio of from about 1:12 to about 1:1. In one or more embodiments described above the primary explosive material is present in an amount equal to or greater than about 4 mg.

Another embodiment of the present disclosure is a method including: detecting one or more micro-seismic events created within a portion of a wellbore by a plurality of explosive proppant particles including a reactive core, wherein the explosive proppant particles are introduced into a wellbore using one or more composite structures including: the plurality of explosive proppant particles; a carrier material; a first packaging; and a second packaging; and determining at least one property relating to a fracture network based at least in part on detection of at least one of the micro-seismic events, the property being selected from the group consisting of: distribution of proppant particles within a fracture network, dimensions of a fracture network, geometry of a fracture network, and any combination thereof.

In one or more embodiments described in the preceding paragraph, the first packaging is fully disposed within the second packaging. In one or more embodiments described above, the first packaging is coupled to and disposed adjacent to the second packaging. In one or more embodiments described above the reactive core includes a primary explosive material and a secondary explosive material. In one or more embodiments described above the primary explosive is selected from the group consisting of: potassium azidodisulfate, bismuth nitride, a mixture of magnesium and iodopentoxide, a mixture of magnesium and silver nitrate, a mixture of magnesium and ceric ammonium nitrate, a mixture of magnesium and barium peroxide, a mixture of metal and iodine, and a mixture of boron and silver difluoride. In one or more embodiments described above the secondary explosive is selected from the group consisting of copper(I) 5-nitrotetrazolate (DBX-1), lead azide, potassium-graphite, magnesium-iodine, a mixture of magnesium and barium peroxide, a mixture of aluminum and iodine, sodium aluminum hydride, a mixture of magnesium and silver nitrate, and a mixture of magnesium and ceric ammonium nitrate.

Another embodiment of the present disclosure a composite structure for generating a micro-seismic event within a wellbore including: a first packaging defining a generally spherical enclosure; a second packaging; a carrier material disposed within the packaging; and at least one explosive proppant particle surrounded by the carrier material.

In one or more embodiments described in the preceding paragraph, the first packaging is fully disposed within the second packaging. In one or more embodiments described above, the first packaging is coupled to and disposed adjacent to the second packaging. In one or more embodiments described above, the first packaging includes a material that degrades in response to a stimulus selected from the group consisting of a temperature change, a pH change, a pressure change, a pressure gradient change, a chemical solution, a chemical reaction, an ultraviolet source, and a nuclear source and the second packaging includes a material that degrades in response to a stimulus selected from the group consisting of a temperature change, a pH change, a pressure change, a pressure gradient change, a chemical solution, a chemical reaction, an ultraviolet source, and a nuclear source.

Another embodiment of the present disclosure a composite structure for Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
introducing one or more composite structures into a portion of a wellbore, wherein the one or more composite structures each comprise:
a plurality of explosive proppant particles comprising a reactive core;
a carrier material;
a first packaging; and
a second packaging;
allowing one or more of the composite structures to reach a location within the portion of the wellbore;
exposing the plurality of explosive proppant particles within the first packaging or the second packaging; and
triggering the reactive core of the exposed explosive proppant particles to create a plurality of micro-seismic events.

2. The method of claim 1, wherein the reactive core comprises a total amount of explosive materials that is less than or equal to about 50 mg.

3. The method of claim 1, wherein the first packaging is fully disposed within the second packaging.

4. The method of claim 1, wherein the first packaging is coupled to and disposed adjacent to the second packaging.

5. The method of claim 1, wherein exposing the plurality of explosive proppant further comprises:
allowing the first packaging to at least partially degrade in response to exposure to a first stimulus; and
allowing the second packaging to at least partially degrade in response to exposure to a second stimulus.

6. The method of claim 5, wherein:
the first stimulus is selected from the group consisting of erosion, impact, shear forces, a temperature change, a pH change, a pressure change, a pressure gradient change, a chemical solution, a chemical reaction, an ultraviolet source, and a nuclear source; and
the second stimulus is selected from the group consisting of a temperature change, a pH change, a pressure change, a pressure gradient change, a chemical solution, a chemical reaction, an ultraviolet source, and a nuclear source.

7. The method of claim 1, wherein introducing the composite structure into a portion of a wellbore further comprises:
placing one or more composite structures into a ball launcher;
inserting the composite structure into a wellbore treatment fluid; and
injecting the wellbore treatment fluid into the portion of the wellbore.

8. The method of claim 1, wherein the reactive core comprises a primary explosive material and a secondary explosive material.

9. The method of claim 8, wherein:
the primary explosive is selected from the group consisting of: potassium azidodisulfate, bismuth nitride, a mixture of magnesium and iodopentoxide, a mixture of magnesium and silver nitrate, a mixture of magnesium and ceric ammonium nitrate, a mixture of magnesium and barium peroxide, a mixture of metal and iodine, and a mixture of boron and silver difluoride; and
the secondary explosive is selected from the group consisting of copper(I) 5-nitrotetrazolate (DBX-1), lead azide, potassium-graphite, magnesium-iodine, a mixture of magnesium and barium peroxide, a mixture of aluminum and iodine, sodium aluminum hydride, a mixture of magnesium and silver nitrate, and a mixture of magnesium and ceric ammonium nitrate.

10. The method of claim 8, wherein the primary explosive material and the secondary explosive material are present in amounts having a ratio of from about 1:12 to about 1:1.

11. The method of claim 8, wherein the primary explosive material is present in an amount equal to or greater than about 4 mg.

12. A method comprising:
detecting one or more micro-seismic events created within a portion of a wellbore by a plurality of explosive proppant particles comprising a reactive core, wherein the explosive proppant particles are introduced into a wellbore using one or more composite structures comprising:
the plurality of explosive proppant particles;
a carrier material;
a first packaging; and
a second packaging; and
determining at least one property relating to a fracture network based at least in part on detection of at least one of the micro-seismic events, the property being selected from the group consisting of: distribution of proppant particles within a fracture network, dimensions of a fracture network, geometry of a fracture network, and any combination thereof.

13. The method of claim 12, wherein the first packaging is fully disposed within the second packaging.

14. The method of claim 12, wherein the first packaging is coupled to and disposed adjacent to the second packaging.

15. The method of claim 12, wherein the reactive core comprises a primary explosive material and a secondary explosive material.

16. The method of claim 15, wherein:
the primary explosive is selected from the group consisting of: potassium azidodisulfate, bismuth nitride, a mixture of magnesium and iodopentoxide, a mixture of magnesium and silver nitrate, a mixture of magnesium and ceric ammonium nitrate, a mixture of magnesium and barium peroxide, a mixture of metal and iodine, and a mixture of boron and silver difluoride; and
the secondary explosive is selected from the group consisting of copper(I) 5-nitrotetrazolate (DBX-1), lead azide, potassium-graphite, magnesium-iodine, a mixture of magnesium and barium peroxide, a mixture of aluminum and iodine, sodium aluminum hydride, a mixture of magnesium and silver nitrate, and a mixture of magnesium and ceric ammonium nitrate.

17. A composite structure for generating a micro-seismic event within a wellbore comprising:
a first packaging defining a generally spherical enclosure;
a second packaging;
a carrier material disposed within the first packaging; and
at least one explosive proppant particle surrounded by the carrier material.

18. The composite structure of claim 17, wherein the first packaging is fully disposed within the second packaging.

19. The composite structure of claim 17, wherein the first packaging is coupled to and disposed adjacent to the second packaging.

20. The composite structure of claim 17, wherein:
the first packaging comprises a material that degrades in response to a stimulus selected from the group consisting of a temperature change, a pH change, a pressure change, a pressure gradient change, a chemical solution, a chemical reaction, an ultraviolet source, and a nuclear source and
the second packaging comprises a material that degrades in response to a stimulus selected from the group consisting of a temperature change, a pH change, a pressure change, a pressure gradient change, a chemical solution, a chemical reaction, an ultraviolet source, and a nuclear source.
